(19) United States
(12) Patent Application Publication
(10) Pub. No.: US 2002/0038228 A1
(43) Pub. Date: Mar. 28, 2002

(54) Systems and methods for analyzing business processes

(76) Inventors: Jerry A. Waldorf, West Hills, CA (US); Alexander Demetriades, Pasadena, CA (US); Alex Andrianopoulos, Pasadena, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/820,277

(22) Filed: Mar. 28, 2001

Related U.S. Application Data
(60) Provisional application No. 60/192,523, filed on Mar. 28, 2000.

(51) Int. Cl. G06F 17/60; G06F 15/16

(52) U.S. Cl. 705/7; 709/205; 709/224

(57) ABSTRACT

The present invention relates to systems and methods that allow business analysts to quickly identify inefficiencies and latencies in distributed business processes. A model of the business process is created. The model identifies activities that are part of the business process. When activities of the business process are initiated and completed, the status of the activities is reported over a network, such as in a data queue. The activities corresponding to the monitored business process are detected and monitored as the activities are reported over the network. The activities of many instances of the business process are monitored and tracked. An activity is further identified in a data store with the instance to which the activity belongs. Thus, activities relating to a single instance of the process can be analyzed. One embodiment combines and relates other aspects and parameters of the monitored business process to the activities of individual instances.

### RELATED APPLICATION

This application claims the benefit under 35 U.S.C. §119(e) of U.S. Provisional Application No. 60/192,523, filed Mar. 28, 2000, the entirety of which is hereby incorporated by reference.

### BACKGROUND OF THE INVENTION

1. Field of the Invention

The present invention relates to systems and methods useful for improving the efficiency of business processes. In particular, the present invention relates to systems and methods for increasing efficiencies of distributed business processes under the control of multiple computer systems.

2. Background

Businesses are always interested in improving the speed of their processes. Improvements in speed can lead to cost savings, greater customer satisfaction, and better retention of a valuable customer base.

A typical business process includes sequential steps. That is, in some circumstances, the business completes one activity before commencing another. For example, a business may verify credit before shipping goods. Processes that include sequential steps are particularly sensitive to inefficiencies because a delay in one activity can directly delay the completion of the entire sequence.

Businesses typically spend inordinate sums of money streamlining processes, reducing delays, and analyzing business trends. Due to the law of diminishing returns, as processes become more efficient, further improvements to processes become harder and more difficult to find. Even processes that were sufficiently efficient in the past can require fine-tuning by business analysts as conditions change. For example, a vendor that used to perform a certain activity can discontinue that line of business. In another example, a change in an environmental law may require that an existing activity be performed in a different way or performed at a different location. Thus, processes are always in a state of flux and in constant need of fine-tuning and improvement.

In a typical business, and especially a business engaged in e-commerce, processes are often already at least partially supervised by multiple electronic and computer systems. Ironically and counter-intuitively, increased automation can make process improvements harder to locate. A common drawback resulting from automation is a decrease in process coordination when automated activities are distributed among several external computer systems that are located and maintained by separate business entities. The external computer systems can execute a variety of different applications and render tracking of individual instances very difficult.

In a conventional system with interconnected external computer systems, a business analyst, at best, has access to a length of time that it takes for an entire process to complete. To determine in detail how long each step in one instance of an activity took, the business analyst examines the records of all the external systems and manually searches for the activity in each corresponding to the instance. Manually searching through multiple records of external systems is very time consuming, expensive, and inefficient. When those external systems operate within the confines of another business entity at a remote site, manual searching of records is often impractical.

### SUMMARY OF THE INVENTION

The present invention overcomes these drawbacks and other problems by providing a business analyst with systems and methods that can assist the business analyst to identify and enhance deficient business process activities, measure the effect of changes to processes, predict business trends and the like. By identifying the deficient activities and the cause of the deficiencies, the business analyst can improve upon the processes and enhance the efficiency of the business.

One embodiment of the present invention monitors individual instances of a process and identifiably maintains the collected data for the individual instances. Advantageously, embodiments of the present invention can be used with computers in distributed systems, which may not have compatible formats. This situation is particularly common when the systems belong to or are operated by different entities. Rather than require all businesses to standardize on systems and messaging standards, so that their processes may be monitored, one embodiment of the present invention can translate and reformat messages to allow one system to communicate with another.

Since the information of individual instances is retained, the business analyst can easily identify bottlenecks and problematic activities. The present invention is particularly advantageous where a business process is distributed over several computer systems in remote locations, as the business analyst is freed from the labor intensive process of manually searching through records of the remote systems.

A model of the business process is created, where elements in the modeled business process correspond to activities of the monitored business process. The start of a monitored portion of an instance of the business process is detected and the duration of time that it takes for an activity from the instance of the business process to complete is tracked. In one embodiment, the start and stop times of the activity are monitored and the duration is computed.

Some business processes require the participation of many disparate computer systems, which are located in areas remote from each other and operated by separate entities. The disparate computer systems implementing activities of the business process typically have incompatible message formats and cannot directly interact. For example, the message format specified for a credit agency may differ from the message format for a warehouse. In one embodiment, a message translator translates or maps the messages with various message formats into a format of a queue used to initiate and track activities. Messages from the queue are translated to the appropriate format of the recipient computer system.

One embodiment of the present invention advantageously monitors network traffic into and out of the queue. Because the data transferred to the queue is in a common message format, i.e., the format of the queue, the embodiment can monitor the interaction of systems that are otherwise very difficult to monitor. The queue is accessible by the computers implementing the business process so that the computers can receive commands and report status.

Systems that participate in the monitored business process can communicate with each other by reading and writing messages to the queue. A system controlling the business process writes a message to the queue. A system performing an activity reads a request for the activity from the queue, and performs the activity if the activity is directed to the activity performing system. When the activity is complete, the activity performing system acknowledges the status by writing a message to the queue.

In one embodiment, the queue is split into an input and an output queue. The input queue holds records of activities to be performed. The output queue holds records of a status of an activity. By monitoring the traffic into and out of the queues, process parameters, such as metrics and attributes, can be collected on an activity-by-activity basis.

In addition, embodiments of the present invention advantageously provide correlation of business process metrics to business process attributes. Analytical techniques aid in the identification of business attributes or properties that adversely affect or beneficially affect the operation of a given business process. For example, a customer return rate can be easily compared against a vendor for a particular item.

Activities of an instance of the business process are further identifiably maintained in a data store such that the instance can be analyzed by its constituent activities. In another embodiment, the modeled business process includes controls for the business process, such that the business process is both monitored and controlled by one application.

Additional attributes, such as status indications and user notes, can also be associated with the activities of the instance. In one embodiment, the elements of the modeled business process are displayed with collected duration times and attributes of selected instances. The instances can be selected by, for example, selecting those instances with activities that took longer to complete than a maximum expected time. One embodiment further compensates for non-working days such as holidays and weekends by ignoring non-working days in a computation of the duration of the activity. In one embodiment, the additional attributes include data such as a vendor name, a product part number, a component part number, a component cost, a profit margin, and the like. The additional attributes can be collected in real time or can be retrieved or computed after execution of the instance of the process, by, for example, receiving profit data from an accounting application.

An embodiment according to the present invention can further include statistical analysis of the collected data. The statistical analysis can further include textual or graphical representations of collected data. For example, graphs of data may be generated, including bar charts, X-Y graphs, and the like.

### BRIEF DESCRIPTION OF THE DRAWINGS

These and other features of the invention will now be described with reference to the drawings summarized below. These drawings and the associated description are provided to illustrate preferred embodiments of the invention, and not to limit the scope of the invention.

FIG. 1 consists of FIGS. 1A and 1B and illustrates an exemplary system that can implement an embodiment of the present invention.

FIG. 2 consists of FIGS. 2A and 2B and illustrates a first data structure that can be used by a system to maintain a knowledge store.

FIG. 3 illustrates a second data structure that can be used to maintain a queue.

FIG. 4 is a flowchart of a process for monitoring an instance of a process.

FIG. 5 is a flowchart of a process where an application reads a task from the queue.

FIG. 6 is a flowchart of a process where a system reads a record in the queue.

FIG. 7 is a flowchart illustrating an overview use of the system.

FIG. 8 illustrates a sample display that indicates a status of the activities of an instance.

FIG. 9 illustrates a sample display of a histogram of instances.

FIG. 10 illustrates a top-level view of an application of a system to a business-to-business environment.

### DETAILED DESCRIPTION OF THE PREFERRED EMBODIMENTS

In a competitive business environment, incremental improvements to processes can determine which businesses prevail in the marketplace. An embodiment of the present invention allows a business analyst to quickly identify activities that are inefficient and helps businesses improve their processes. In contrast to conventional systems, where a business analyst has little insight into the cause of a poorly executed instance of the process unless the business analyst manually examines the individual activities comprising the poorly executed instance, embodiments of the present invention allow for the quick and efficient identification of process bottlenecks.

Conventional methods of examining individual instances of a process consume a great deal of time. In a typical business process, the instance records lie in different applications in different computers executing different operating systems hidden beneath an enormous amount of data. Embodiments of the present invention allow business analysts to advantageously examine the details of an individual instance of a process without having to manually search through multiple records of external systems.

In one embodiment, the messages from some or all of the systems participating in the distributed business process are translated and reformatted before being placed on a network interconnecting the systems. The translation and reformatting allows one system to communicate with another, though they may be using different operating systems and internal messaging formats. In one embodiment, each system communicates over the network in a format used by a queue. Tasks of the distributed business process can be initiated at the queue connected to the network. A system controlling or monitoring the queue can thus monitor and store detailed information about the activities performed by the distributed system.

Significantly, the analyst is relieved of a substantial bulk of the chores and burdens of maintaining processes, thus allowing the analyst to fine-tune the processes to enhance the productivity of the business. A real-time notification of failed process instances is optionally provided to allow the business analyst to investigate and improve the process in real-time.

Although this invention will be described in terms of certain preferred embodiments, other embodiments that are apparent to those of ordinary skill in the art, including embodiments which do not provide all of the benefits and features set forth herein, are also within the scope of this invention. Accordingly, the scope of the present invention is defined only by reference to the appended claims.

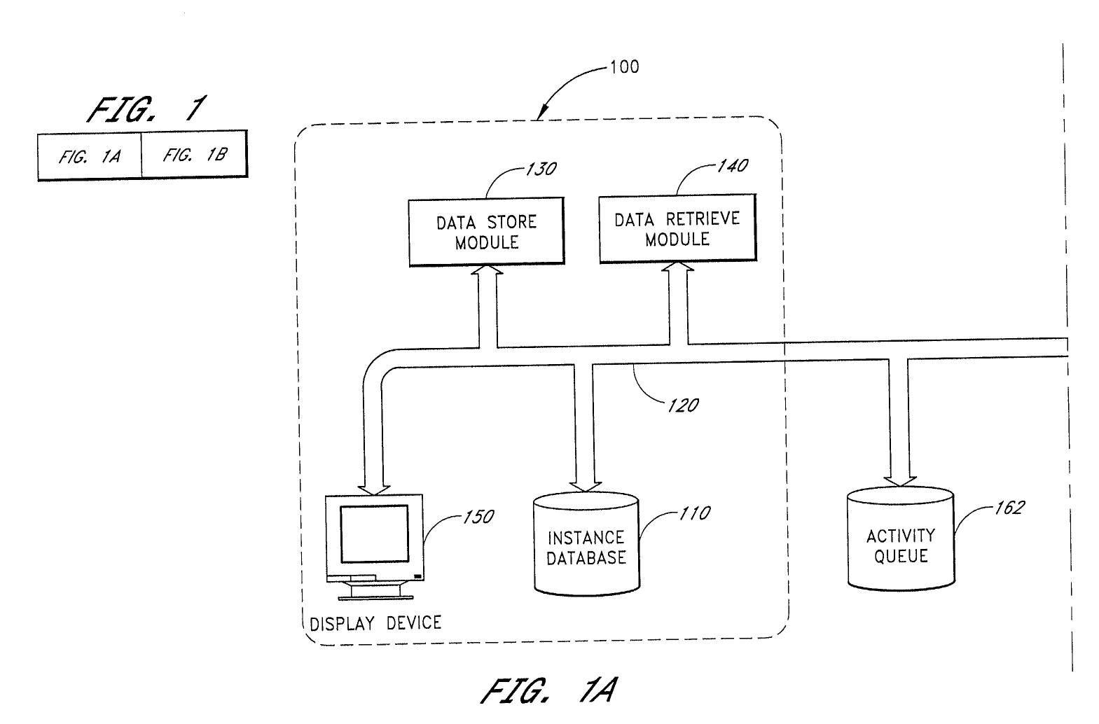

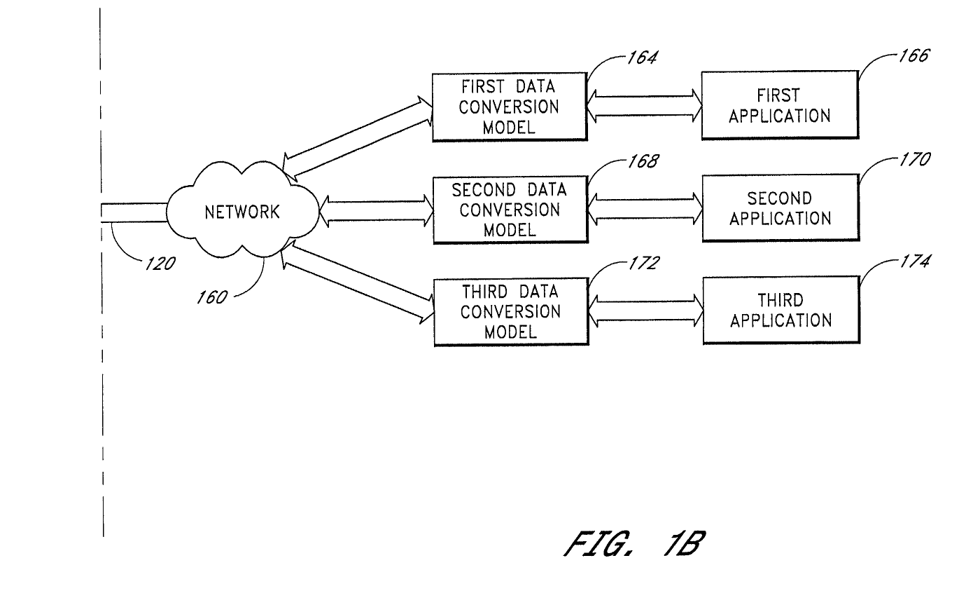

FIG. 1 illustrates an exemplary system 100 and an environment in which an embodiment of the present invention can be practiced. Advantageously, the exemplary system 100 can be remotely located from the other components in the environment. The exemplary system 100 includes an instance database 110, a communication medium 120, a data store module 130, a data retrieve module 140, and a display device 150. FIG. 1 further illustrates the exemplary system 100 interacting through a network 160, an activity queue 162, a first data conversion module 164, a first application 166, a second data conversion module 168, a second application 170, a third data conversion module 172, and a third application 174.

It will be understood by one of ordinary skill in the art that the instance database 110 may be implemented on an addressable storage medium in a variety of mediums. For example, the instance database 110 can be entirely contained in a single device or it could be spread over several devices or servers in a network. The instance database 110 can be implemented in such devices as memory chips, hard drives, and optical drives.

In the exemplary system 100 shown, the instance database 110 is connected via a communication medium 120 with other modules. One of these modules is the data store module 130, which stores data into the instance database 110. The instance database 110 can include various data storage devices, be they electrical, magnetic, or optical, either internal or remote. The data retrieve module 140, extracts information from the instance database 110. The data store module 130 and the data retrieve module 140 include methods such as responding to a keyboard, voice recognition, the use of a mouse or trackball, the use of touch sensitive screens, the use of specific software, and the use of relational databases such as Microsof® Access. The data retrieve module 120 further includes methods such as searching the instance database 110 for keywords and navigation within the instance database 110. The exemplary system 100 also shows a display device 150 shown in FIG. 1 as a cathode ray tube (CRT) monitor. The display device can include other forms of display devices such as liquid crystal display (LCD) monitors, projectors, printers, and speakers.

The exemplary system 100 may include one or more computers. A computer can be any microprocessor or processor (hereinafter referred to as processor) controlled device, including, but not limited to terminal devices, such as a personal computer, a workstation, a server, a client, a mini computer, a main-frame computer, a laptop computer, a network of individual computers, a mobile computer, a palm top computer, a hand held computer, a set top box for a TV, an interactive television, an interactive kiosk, a personal digital assistant, an interactive wireless communications device, a mobile browser, or a combination thereof. The computers may further possess input devices such as a keyboard, a mouse, a trackball, a touch pad, or a touch screen and output devices such as a computer screen, printer, speaker, or other input devices now in existence or later developed.

These computers may be uniprocessor or multiprocessor machines. Additionally, these computers include an addressable storage medium or computer accessible medium, such as random access memory (RAM), an electronically erasable programmable read-only memory (EEPROM), hard disks, floppy disks, laser disk players, digital video devices, compact disks roms, dvd-roms, video tapes, audio tapes, magnetic recording tracks, electronic networks, and other techniques to transmit or store electronic content such as, by way of example, programs and data. In one embodiment, the computers are equipped with a network communication device such as a network interface card, a modem, Infra-Red (IR) port, or other network connection device suitable for connecting to a network. Furthermore, the computers execute an appropriate operating system such as Linux, Unix, Microsoft® Windows® 3.1, Microsoft® Windows® 95, Microsoft® Windows® 98, Microsoft® Windows® NT, Microsoft® Windows® 2000, Microsoft® Windows® Me, Apple® MacOS®, IBM® OS/2®, Microsoft® Windows® CE, or Palm OS®. As is conventional, the appropriate operating system may advantageously include a communications protocol implementation, which handles all incoming and outgoing message traffic passed over the network. In other embodiments, while the operating system may differ depending on the type of computer, the operating system may continue to provide the appropriate communications protocols necessary to establish communication links with the network.

The computers may advantageously contain program logic, or other substrate configuration representing data and instructions, which cause the computer to operate in a specific and predefined manner as described herein. In one embodiment, the program logic may advantageously be implemented as one or more modules. The modules may advantageously be configured to reside on the addressable storage medium and configured to execute on one or more processors. The modules include, but are not limited to, software or hardware components, which perform certain tasks. Thus, a module may include, by way of example, components, such as, software components, object-oriented software components, class components and task components, processes, methods, functions, attributes, procedures, subroutines, segments of program code, drivers, firmware, microcode, circuitry, data, databases, data structures, tables, arrays, and variables.

The depicted components may advantageously communicate with each other and other components comprising the respective computers through mechanisms such as, by way of example, interprocess communication, remote procedure call, and other various program interfaces. Furthermore, the functionality provided for in the components, modules, and databases may be combined into fewer components, modules, or databases or further separated into additional components, modules, or databases. Additionally, the components, modules, and databases may advantageously be implemented to execute on one or more computers. In another embodiment, some of the components, modules, and databases may be implemented to execute on one or more computers external to the exemplary system 100. In this instance, the exemplary system 100 includes program logic, which enables the exemplary system 100 to communicate with the externally implemented components, modules, and databases to perform the functions as disclosed herein.

The activity queue 162 can be used to post activities to be performed by and to post status from the applications 166, 170, 174. An implementation of the activity queue 162 is described in more detail in connection with FIG. 3.

In one embodiment, the first data conversion module 164 converts the messages to and from the first application 166 to a format readable by the activity queue 162 and the exemplary system 100. Similarly, the second and the third data conversion modules 168, 172 respectively convert the messages to and from the second and the third applications 170, 174 to the format. The conversion to the format advantageously allows a distributed business process to be controlled and monitored at a remote location.

The applications 166, 170, 174 can execute on distant computers. The distant computers can be located in remote geographical locations and may be associated with different companies or entities. The network 160 includes any medium suitable for the transmission of data including internal networks and external networks, private networks and public networks (such as the Internet), and wired, optical, and wireless networks. It will be understood by one of ordinary skill in the art that such data may be encrypted. The applications indicated by the first application 166, the second application 170, and the third application 174 can reside within an internal network or beyond the firewall of the internal network and at a business partner.

To illustrate the environment using a simple e-commerce example, the first application 166 may be a customer order taking system 166. A customer can order a product, such as a blue shirt, through an interface including the first application 166. The second application 170 can be a credit check through a separate credit-verifying agency such as TRW. The third application 174 can be a warehouse application to pull an item from stock.

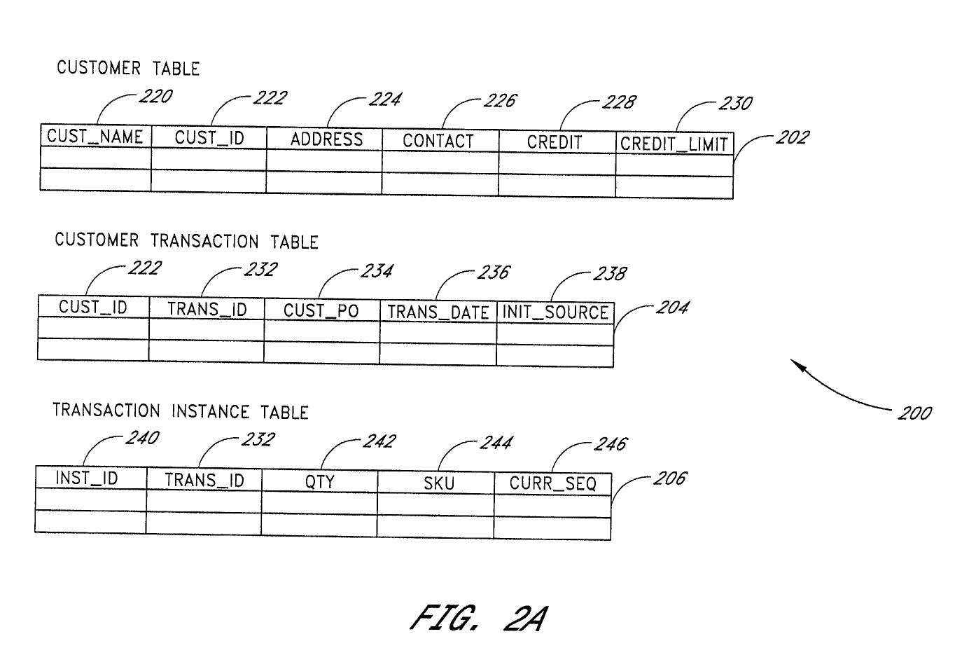

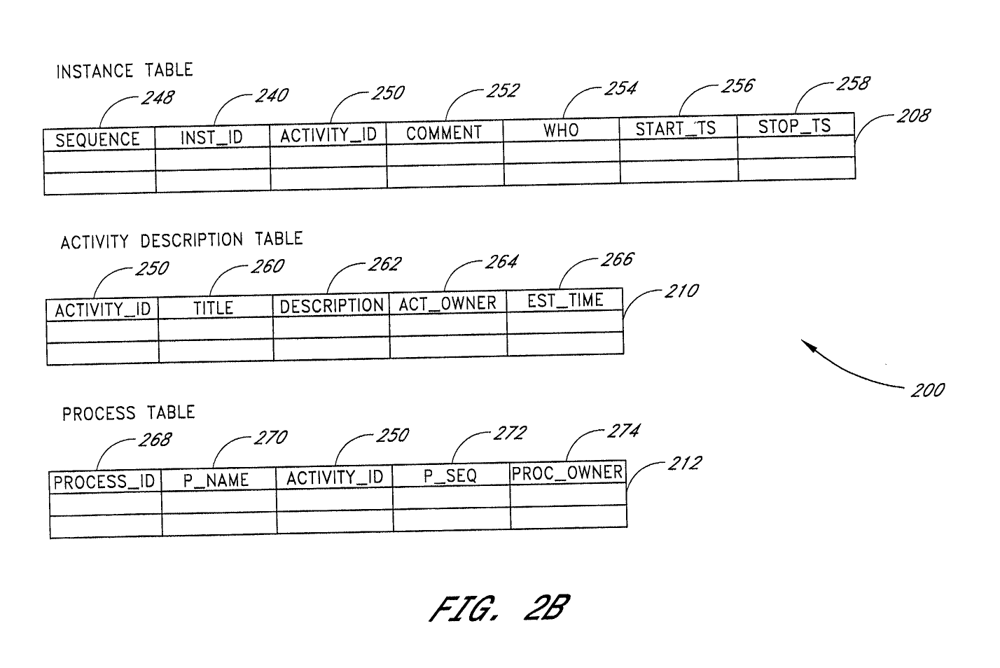

FIG. 2 is one embodiment of an exemplary first data structure 200, which can maintain a knowledge base of information for use with the present invention to monitor the efficiency of a process. For clarity, the embodiment shown controls the process and monitors the process. Another embodiment simply monitors the process passively without control.

By way of example, the first data structure 200 demonstrates a data structure useful for the control and monitor of an e-commerce transaction. It will be understood by one of ordinary skill in the art that similar data structures may be used to control and monitor other processes. The first data structure 200 advantageously captures detailed information about the individual instances and activities of a distributed business process.

Though the first data structure 200 shown has the form of a relational database, one of ordinary skill in the art will recognize that the database may also be, by way of example, an object oriented database, a hierarchical database, a lightweight directory access protocol (LDAP) directory, an object oriented-relational database, and the like. The databases may conform to any database standard, or may even conform to a non-standard, private specification. In one embodiment, the system uses a database that complies with a SQL ANSI 92 standard. The database can also be implemented utilizing any number of commercially available database products such as, by way of example, Oracle® from Oracle Corporation, SQL Server and Access from Microsoft Corporation, Sybase® from Sybase, Incorporated and the like.

The data structure 200 shown utilizes a relational database management system (RDBMS). In a RDBMS, the data is stored in the form of tables. Conceptually, the data within the table is stored within fields that are arranged into columns and rows. Each field contains one item of information. Each column within a table is identified by its column name and contains one type of information, such as the name of a process. A record, also known as a tuple, contains a collection of fields constituting a complete set of information. In one embodiment, the ordering of rows does not matter as the desired row can be identified by examination of the contents of the fields in at least one of the columns or by a combination of fields.

By way of example, six tables are shown in the first data structure 200. These tables are a Customer Table 202, a Customer Transaction Table 204, a Transaction Instance Table 206, an Instance Table 208, an Activity Description Table 210, and a Process Table 212. The exemplary data structure 200 illustrates a convenient way to maintain data such that an embodiment using the data structure 200 can store and retrieve the data therein. The exemplary first data structure 200 further advantageously stores a snapshot of processes used by an instance which are no longer in use, as well as processes which are in present use.

The Customer Table 202 shown contains six fields and contains customer information often duplicated. These fields are a Cust_Name field 220, Cust_ID field 222, Address field 224, Contact field 226, Credit field 228, and Credit_Limit field 230. The Cust_Name field 220 can contain the name of a customer. The Cust_ID field can contain a unique identifier to identify a record in the Customer Table 202. As will be understood by one of ordinary skill in the art, each valid record in a relational database table should be identifiable by a unique entry in a field or combination of fields. The Address field 224, the Contact field 226, the Credit field 228 and Credit_Limit field 230 can contain a street address, a name of a contact, an amount of credit extended, and a credit limit. Additional fields can be used to store other addresses, phone numbers, etc.

The Customer Transaction Table 204 shown contains five fields and contains transaction details related to the customer, which are often duplicative. The Cust_ID field 222 indicates the customer corresponding to the transaction by reference to the corresponding record in the Customer Table 202. In some embodiments, the reference is a pointer. A Trans_ID field 232 contains a unique identifier to relate a record in the Customer Transaction Table 204 to a particular transaction. A Cust_PO field 234 stores the customer's purchase order number. A Trans_Date field 236 can store a date and time stamp of the transaction. An Init_Source field 238 can store an initiation point for the process. For example, an on-line merchant may receive orders from several different portals. The Init_Source field 238 can further include a transaction-related identifier from an external source to enable the embodiment to easily cross reference to the activity in an initiating application.

The Transaction Instance Table 206 shown contains five fields and stores more detail about the transaction. The Trans ID field 232 relates records in the Transaction Instance Table 206 to a particular transaction. One transaction can have multiple instances. For example, if the customer ordered shoes and socks in one transaction, the shoes may require ordering through a distributor whereas the socks may be in stock. The process for ordering shoes can differ from the process for ordering socks, and the separate instances of these processes can be identified by an entry within an Inst_ID field 240. In the Transaction Instance Table 206, the Inst_ID field 240 identifies records. A Qty field 242 and SKU can store additional details about the instance, such as a quantity of goods and a SKU number for those goods. A Curr_Seq field 246 can indicate which activity in the instance is currently in process.

The Instance Table 208 shown contains seven fields and stores detail about the instance. The Inst_ID field 240 identifies those records in the Instance Table 208 which refer to activities belonging to the same instance. Thus, one instance of a particular process with many activities eventually accumulates multiple records in the Instance Table 208. A Sequence field 248 identifies an ordering of activities within an instance of a sequential process. The ActivityID field 250 relates the activity for the particular instance to a record in the Activity Description Table 210 which contains details describing the activity which are common to multiple instances of the activity. A Comment field 252 enables a business analyst, worker, or an application to enter a remark about the performance of the activity. The remark can be entered manually or automatically, during or after execution of the instance, by the business analyst, worker, or the application. The remark within the Comment field 252 can advantageously archive an explanation for a variation from an expected performance for the activity. The explanation can be interpreted later by the business analyst when the business analyst inspects the instance. The explanation can help to determine if the activity suffers from a correctable defect and needs adjustment or if the instance of the activity suffered from an extraordinary and unique problem.

A Who field 254 indicates the business analyst, worker, or the application which made the entry in the Comment field 252. A Start_TS field 256 can include a timestamp indicating a starting time and date for the activity in the instance. A Stop TS field 258 can include a timestamp indicating a completion time and date for the activity in the instance. In alternative embodiments, the Instance Table 208 can further include fields for other attributes tailored to the instance. For example, additional fields can store a priority level (low, normal, urgent), an indication for message standards used, etc.

The Activity Description Table 210 shown contains five fields and can describe the nature of an activity. The activity can be performed in and referenced by multiple instances of multiple processes. Records in the Activity Description Table 250 can include information describing how to perform the activity. For example, the Activity Description Table 210 can include a Title field 260 containing a name for the activity, such as “Check Credit.” The Activity Description Table 210 can include a Description field 262 which can store instructions for executing the activity, or an address for a system executing the activity, a data format, etc. An Act_Owner field 264 can store a person or organization responsible for maintaining the activity. An Est_Time field 266 can include an entry relating to an estimated duration for the activity. One embodiment uses the contents of the Est Time field 266 to select instances of process where an activity exceeded the estimated duration. Another embodiment compares the estimated duration to the duration of the activity in real time and alerts the business analyst of an instance of a process gone awry.

A Process Table 212 shown contains four fields and can define a process by associating related activities within the Activity Description Table 210. A process described within the Process Table 212 can be identified by an entry stored within a Process_ID field 268. The process can include several activities. Thus, several records in the Process Table 212 can share a common identifier within the Process_ID field 268. A name for the process can be stored in a P_Name field 270. The Activity_ID field 250 can reference the activities that comprise the process. An entry in a P_Seq field 272 can indicate a position for the activity within a sequential process. A Proc_Owner field 274 can indicate an individual or organization responsible for maintaining the process.

By way of example, a second data structure 300 demonstrates a data structure useful for exchanging information across applications. For example, an embodiment may wish to communicate with an order application, a credit checking application, a stock checking application, and a shipping application. Though the second data structure 300 shown also has the form of a relational database, one of ordinary skill in the art will recognize that other database formats may also be used as described in connection with FIG. 2.

The second data structure 300 contains two tables, an Out Table 302 and an In Table 304. The Out Table 302 and the In Table 304 operate as queues. A system operating as an embodiment of the invention, as well as external applications, can access the tables. A record in the Out Table 302 identifies activities to be performed by applications such as the second application 170, shown in FIG. 1. The In Table 304 identifies action to be performed by the system. Hence, a record in the Out Table 302 is similar to a message sent from the system to an application, including an external application. A record in the In Table 302 is correspondingly similar to a message sent from an application to the system. In one embodiment, the network 160 further includes another application to direct traffic across the network and to parse the contents of the records into a format of a recipient of the record or message.

The Out Table 302 shown contains five fields. The system creates a record in the Out Table 302 corresponding to activities to be performed by an application. In alternative embodiments where the embodiment performs a passive monitoring function, the application controlling the process creates the record and the system monitors the presence of records. The fields are a Q1_ID field 310, the Inst_ID field 240, an App_Add field 312, an Instruction field 314, and a Q1_detail field 316. An entry in the Q1_ID field 310 can identify a unique record within the Out Table 302. In one embodiment, the Inst_ID 240 field contains a reference to the instance corresponding to the record in the Out Table 310. The App_Add field 312 can further store a reference, such as an IP address, so that an application reading the record in the database can recognize whether the record applies to the application. An Instruction field 314 can store information relating to the desired activity at the application. For example, the Instruction field 314 can store a request for a transfer of funds. In the exemplary second data structure 300 shown, a Q1_detail field 316 can provide additional details useful for the activity. Using the transfer of funds example, the Q1_detail field can include an account number at a bank and whether the funds are to be transferred from a savings account or a checking account, a transaction amount, and a priority indication. It will be understood by one of ordinary skill in the art that alternate embodiments may use multiple fields and links to other records in other tables for storing details.

The In Table 304 shown contains six fields. Applications, some of which may be external to the system, can enter records in the In Table 304. The system disposes of the records as they are acted upon. Where the system non-invasively monitors processes, an external application such as the application controlling the process disposes of the records as they are acted upon. The fields in the In Table 304 are a Q2_ID field 330, the Inst_ID field 240, the App_Add field 312, an App_ID field 332, a Status field 334 and a Q2_detail field 336. An entry in the Q2_ID field 330 can identify a unique record within the In Table 304. In one embodiment, the Inst_ID field 240 returns the entry sent in the Inst_ID field 240 of the Out Table 302 to enable the embodiment to identify the instance corresponding to the record. The App_Add field 312 again indicates an address for the application. In the context of the In Table 304, the contents of the App_Add field allow the system to determine which application posted the record. A Status 334 field enables an application to report a status of the activity to the system. Exemplary contents for the Status 334 field include indications for a success of a completed activity, a failure of an activity, an activity in process, and a request to initiate a new instance of a process. In some processes, an external application, such as a Web portal, can initiate a process. A Q2_detail field 336 can provide additional details useful for the activity. Examples of the content for the Q2_detail field 336 include customer names, addresses, quantities of product desired, product identifiers, bank account information, etc. It will be understood by one of ordinary skill in the art that alternate embodiments may use multiple fields and links to other records in other tables for storing details.

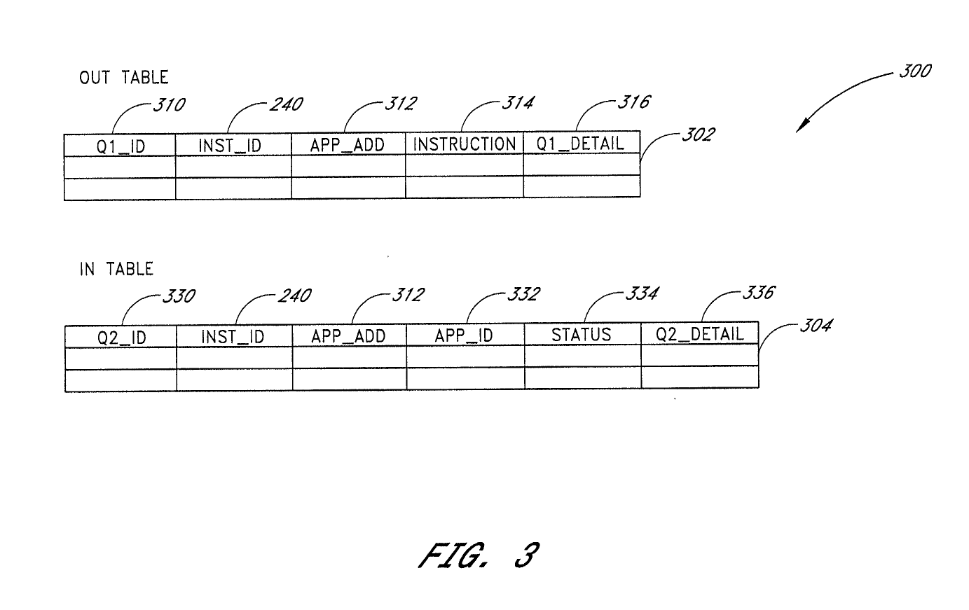

FIG. 4 is a flowchart 400 illustrating an exemplary overview method of monitoring an instance of a process. In State 410, an instance of the process begins. One system includes a module instigating an instance of a process. In another system, an external application generates a record in the In Table 304 and initiates the instance of the process. Where a system acts in a passive monitor mode, the system passively detects the initiation of the process by monitoring the data traffic.

In State 410, the system prepares to initiate an instance of the process. In State 410, the system maintains information such as the customer information found in the Customer Table 202 and generates a unique number for the Trans_ID field 232. The system further stores, in the record corresponding to the unique entry in the Trans_ID field 232, a reference to an existing record in the Customer Table 202. For new customers, an additional record in the Customer Table 202 can be created. For the customer's reference, the system stores the customer's purchase order number in the Cust_PO field 234, a time stamp for the transaction in the Trans_Date field 236, and information corresponding to the initiating activity in the Init_Source field 238 to allow the system to undo the process if so desired.

As part of State 410, the system typically determines which process to initiate. Typically, a process has several activities. In the exemplary data structure 200 shown, each process corresponds to a unique entry in the Process_ID field 268. The records in the Process Table 212 that contain a common entry in the Process ID field 268, correspond to activity identifiers for the process. The system selects the records corresponding to the Process ID and determines the sequence for the activities corresponding to the records by examination of a number stored in the P_Seq field 272. One system initially opens multiple records in the Instance Table 208 corresponding to multiple steps of the process as indicated in the Process table 212. The system also transfers the contents of the P_Seq field 272 to the Sequence field 248 to allow the system to determine the sequence of execution for the activities. One system can identify the instance through the Inst_ID field 240 by creating a link to the Inst_ID in a running table where the table includes a list of those instances presently running. The system can further initialize the Curr_Seq field 246 to zero or equivalent to indicate that the first activity of the process has yet to be performed.

In State 420, the system requests an application to perform an activity or step. The system can simultaneously request and monitor multiple activities of multiple processes. The system determines which activity to perform by requesting the activities in the sequence dictated by the P_Seq field 272. When the system requests an activity for the instance, the system creates a corresponding record in the Instance Table 208. In the Instance Table 208, the system relates the activity to the instance by storing the unique entry corresponding to the instance in the Inst_ID field 240. The system further identifies the activity's sequence in the instance by storing the sequence in the Sequence field 248 and indicates what the activity was by entering a reference to the activity in the Activity_ID field 250. In one embodiment, the records in the Instance Table 208 are created in State 410, and the system in State 420 updates the Start_TS field 256 during execution.

The system advantageously stores a starting time/date stamp in the Start_TS field 256. By storing when the activity for the instance began, the system can measure a duration of the activity. In one embodiment, the system recalls an instruction for requesting activity from the Description field 262 for the activity. The application can reside within the internal network of the system or can reside beyond the company firewall at a system of a business partner. The instruction can indicate the address of the application, a format, a protocol, etc.

In State 430, the system receives an indication from an application. In one embodiment, the system reads records in the In Table 304 on a periodic basis. In another embodiment, the system reads a record in the In Table 304 in response to an interrupt generated by an addition of a new record in the In Table 304. An application sending a message to the system creates a record in the In Table 304. In one embodiment, the application accesses the database directly. In another embodiment, the application sends a message to a parser, which then formats the message into the data structure and enters the record. The Q2_ID field 330 uniquely identifies each record from another. The record further includes the Inst_ID 240 to relate the activity to the instance. If the application is initiating an instance, then the Inst_ID field 240 can be left empty or filled with a default. The application identifies itself with an entry in the App_field 312. In one embodiment, the entry in the App_Add field 312 can correspond to an IP address.

The application stores another reference in the App_ID field 332. In one embodiment, the monitoring system and an application can exist on separate systems, each with its own reference number. The App_ID field 332 stores the reference number of the application for easier tracking of the instance. The application returns a status of the activity in the Status field 334. For example, upon receiving an instruction from the Out Table 302, the application can acknowledge receipt of the instruction by providing an indication in the Status field 334. The monitoring system can then remove the instruction from the Out Table 302. The content of the Status field 334 can further provide an indication to the embodiment to initiate a new instance, or to indicate a success or failure of the activity. The application can report further information in the Q2_detail field 316. For example, if the activity requested pertained to an inquiry for a bank account balance, the application can return an account balance in the Q2_detail field.

When the activity is complete, the system advantageously stores a completion time/date stamp in the Stop_TS field 258 of the record in the Instance Table 208 corresponding to the instance via the Inst_ID field 240 and to the activity via the Activity_ID field 250. Storing the completion time/date stamp allows the system to advantageously calculate a duration for the activity by comparing the content of the Stop_TS field 258 with the content of the Start_TS field 256.

In State 440, the system determines whether there are more activities remaining in the process or whether the process is complete. One system determines whether the instance has completed the process by an exhaustion method, where the system determines that no steps in the process remain to be completed. Exhaustion can be determined by examining the Curr_Seq field 246 for the record corresponding to the instance and searching for a record in the Instance Table 208 with an entry in the Sequence 248 field that corresponds to the next activity in the sequence. If none can be located, then the process is complete. If the process is not complete, the system can increment the Curr_Seq 246 field of the record in the Transaction Instance Table 206 corresponding to the instance. The embodiment then identifies and requests the performance of the next activity. If the activity is complete, the instance can be removed in the running table to indicate that the instance is no longer executing.

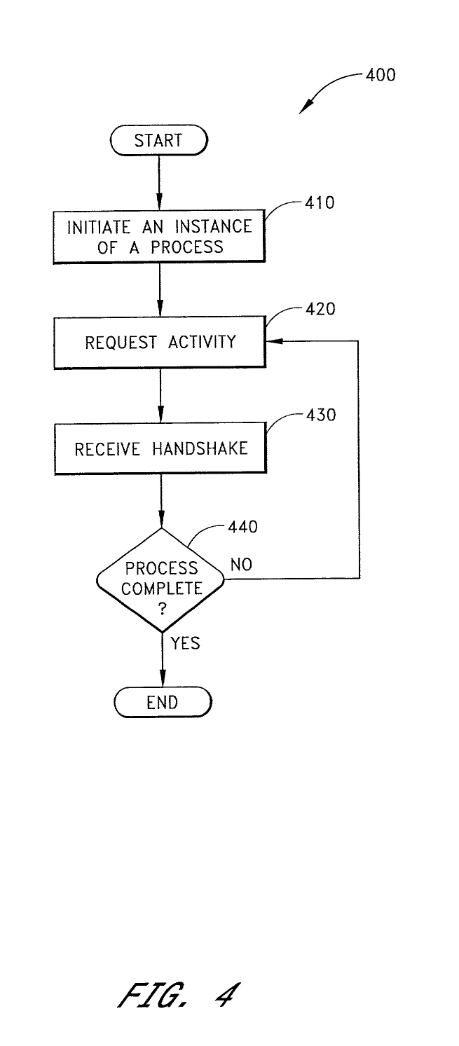

FIG. 5 is a flowchart 500 illustrating an exemplary overview method where an application reads a request for activity from the Out Table 302. In State 510, the application reads a record from the Out Table 302. In one embodiment, the application reads directly from the Out Table 302. In another embodiment, the application reads the record in the Out Table 302 through a parser program. If a parser is used, the parser can additionally filter the data in the records of the Out Table 302 such that an application receives a message that corresponds to the application and not to other applications.

In State 520, the application determines whether the record in the Out Table 302 applies to the application. In one embodiment, the application examines the App_Add field 312 of the record 302 and determines whether the application identifying entry in the App_Add field 312 corresponds to the application. If the entry corresponds, the activity requested in the record is performed. If the entry fails to correspond, then the record corresponds to an activity performed by a different application and the application is dormant for the purposes of the particular record. For example, the record could correspond to a request for verifying an account balance. If the application reading the record corresponds to an application which checks inventory of shoes, then the entry in the App_Add field 312 should not match with the application and the application that checks inventory of shoes ignores the request.

In State 530, having determined that the record corresponds to the application, the application reads the record and performs the requested task. In State 540, the application reports a status of the activity to the In Table 304, which when read, allows the system to proceed to a next activity or step in the process. For example, the status can indicate success or failure of the activity. In one embodiment, the application delivers the status message to a parser, which then creates the new record in the In Table 304.

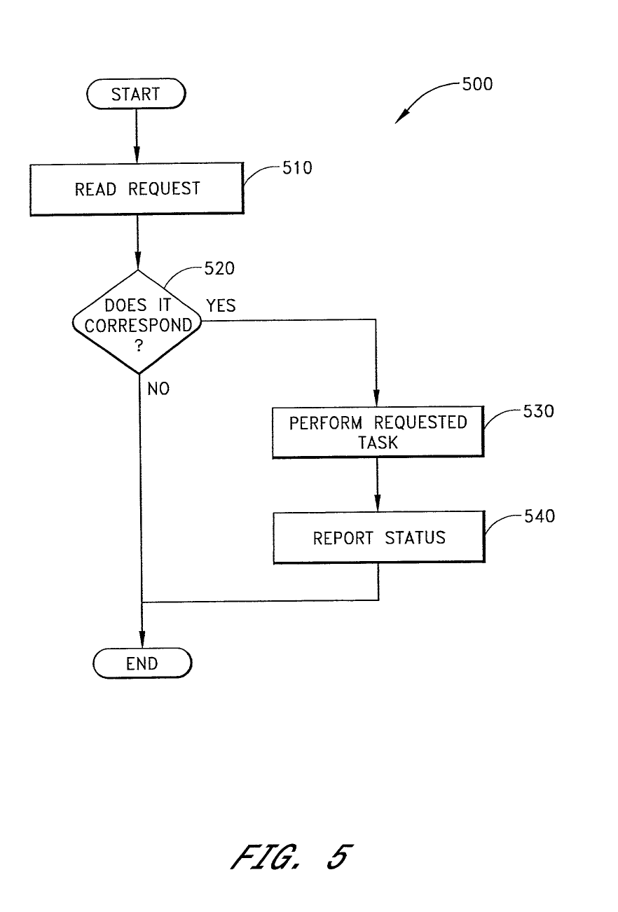

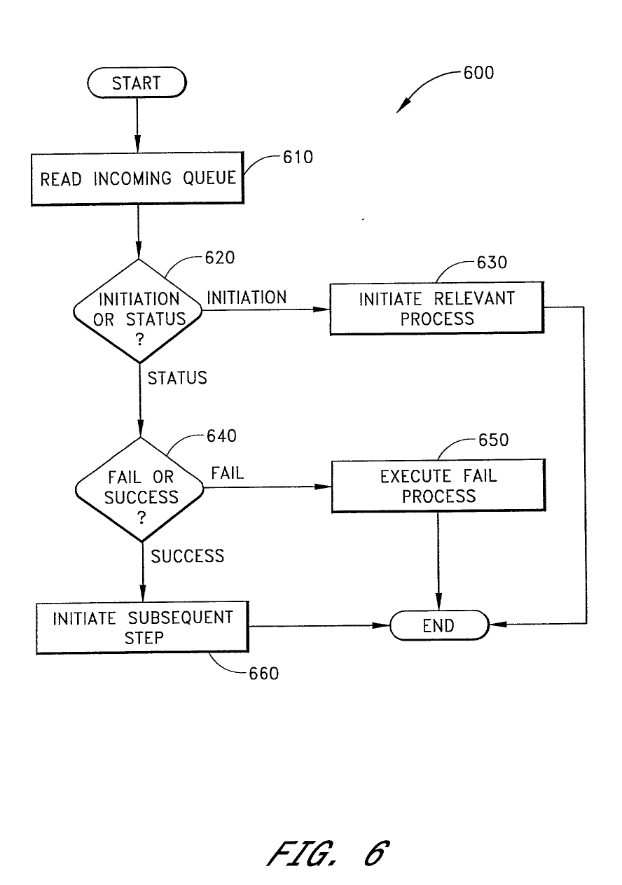

FIG. 6 is a flowchart 600 illustrating an exemplary overview method where the system reads a record from the In Table 304. In State 610, a record is read from the In Table 304. In State 620, the system determines whether the record corresponds to status or is a request to initiate a new instance of a process. For example, a predetermined entry in the Status field 334 can indicate a request to initiate a new instance of a process. If a request is received to initiate a new instance of a process, the process can be initiated as indicated in State 630.

In State 640, the system analyzes the status message to determine whether the activity succeeded or failed. If the activity failed, the system can then execute a fail process as indicated by State 650. The fail process can include undoing the steps previously performed. Upon detection of a failure in the instance, a real-time notification of failed instances can be provided, allowing a business analyst to take corrective measures against failed instances as they occur. In State 660, having received acknowledgement of a successful outcome for the activity requested, the system can initiate the next activity of the process, if any.

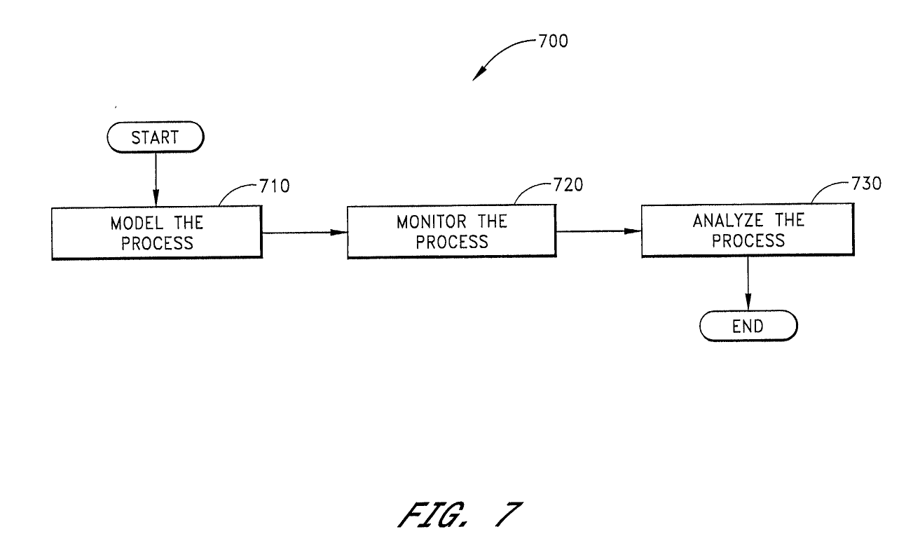

FIG. 7 is a flowchart 700 illustrating an overview use of the system. In State 710, a business analysts designs a model of a process that the system monitors. One embodiment of the system includes a graphical user interface (GUI) to allow a business analyst to create the model by drag and drop operation. In one embodiment, the system allows a business analyst to configure the system to monitor selected attributes and/or metrics. For example, to track a shipping activity, the business analyst can decide to collect and monitor attributes related to the weather. Whereas, in an activity to check credit, the business analyst can decide to collect a different attribute, such as data from a TRW or Experian credit report.

In State 720, the system monitors the process, and the system collects parameters relating to the business process, such as attributes, time metrics, and other metrics. In one embodiment, the system monitors processes in real-time and can indicate failed instances in real time. Real-time monitoring of processes allows a business analyst to institute corrections and adjustments to processes on-the-fly or substantially in real-time. This provides valuable information, which can be used to analyze the business process. For example, the information can be used to analyze how efficient a business process is executing, how much revenue a product is generating, how a new accounting system is impacting the IT enterprise, and the like. In another example, if a credit check activity has failed because of a line connection dropout, the business analyst can examine an error message and attempt to correct the activity. In other embodiments, the system monitors the process and the business analyst examines the collected parameters at a later time as indicated by State 730.

There are generally two types of parameters, either or both of which can be monitored by the system. The two types of parameters include system parameters and business process parameters. System parameters are typically associated with the various computer systems that implement the business process. For example, system parameters can include start and stop times, unique identifiers, and processing states. By contrast, business process parameters are typically associated with the type of activity that is executed, such as an order quantity, product description, delivery, cost to build, cost to ship, vendor identification, sales tax amounts, and the like.

In State 730, the system provides the collected attributes and metrics for inspection and analysis by the business analyst. The analyst may optimize the process in response to process defects uncovered by inspecting the collected data. The analyst may also elect to revise the model of the business process to collect different attributes. The system can further advantageously collect attributes and metrics such that the impact of the changes to the business process can be collected and analyzed.

In one embodiment, the system allows the business analyst to configure the display of instances where selected activities took longer than a pre-selected time interval. One embodiment of the system automatically accounts for and compensates for planned non-working days such as weekends and holidays.

The system further allows the business analyst to configure a display format for the collected attributes and metrics. In one embodiment, the display corresponds to a flowchart of the process used by the instance.

In one embodiment, the system enables a business analyst to configure a flowchart to display symbols depending upon an activity state. In one embodiment, the business analyst can further configure the possible states attainable for an activity, i.e., define the states assignable to an activity.

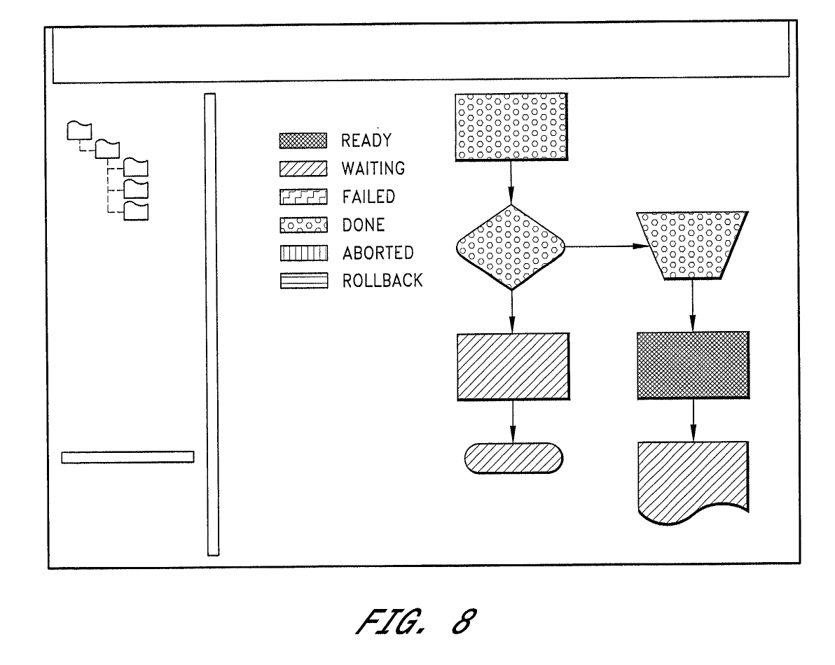

FIG. 8 illustrates an example of defining an activity into a set of states and displaying the status of the states graphically. In FIG. 8, objects in a flowchart are assigned a hatch pattern to indicate the status of the activity corresponding to the object. In one embodiment, color is used to indicate the status. For example, a symbol can take a color in accordance with whether the activity is in a waiting, a running, a done, a failed, a roll-back, or an aborted activity state.

In FIG. 8, the labels assigned to the states are defined as follows:

WAITING: The associated system application is in a state waiting to receive the information necessary to activate a process, i.e., an order entry system is WAITING for a purchase order to transmit so that it can process the purchase order.

RUNNING: The associated system application is currently processing the activity in the manner specified in the business process model.

DONE: The associated system application has completed the activity specified in the business process model.

FAILED: The associated system application FAILED to process or complete an activity. Examples of causes of a FAILED message include:

1) an error message written into an error log file,

2) an alert notice sent through the designated channels,

3) the application stops processing and a backlog of business process instances accumulates dangerously, and

4) other system failure provisions.

ROLLBACK: The activity is in a ROLLBACK state, which restores the system to a preexisting state. Some system applications, particularly databases, have ROLLBACK mechanisms that automatically restore the system to the way it was before a change.

ABORTED: The associated system cancelled the processing of an activity. The cancellation can be user specified or automatic, if the business process logic is programmed appropriately.

Other states include states such as “Never Invoked,” which indicates that the activity had not been initiated during the business process instance, “Undo Completed,” which indicates that the rollback mechanism successfully completed, and “Undo Failed,” which indicates that the rollback mechanism failed to “undo” the corresponding activity.

Table I, below, illustrates one icon color scheme used to identify the state of the corresponding activity.

| State | Color |
|---|---|
| Never Invoked | White |
| Waiting | Yellow |
| Running | Blue |
| Completed | Green |
| Failed | Red |
| Aborted | Olive |
| Rollback | Aqua |
| Undo Completed | Pink |
| Undo Failed | Brown |

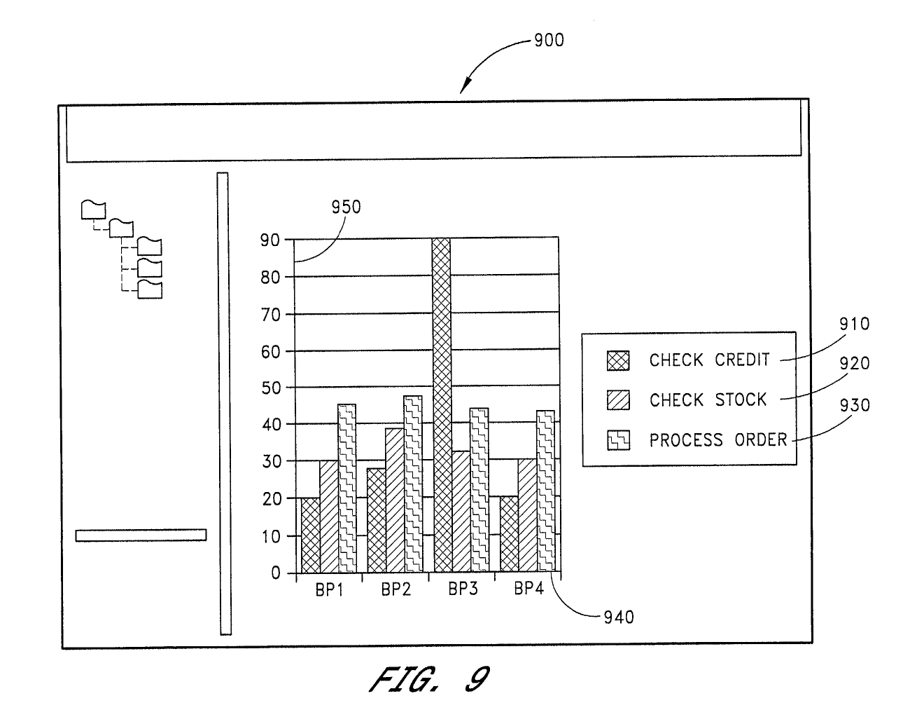

FIG. 9 illustrates a sample display 900 generated by the system showing a histogram of instances. The sample display 900 shows a portion of an exemplary process with 3 activities. These activities are conveniently indicated in the display 900 by color or shading as a Check Credit activity 910, a Check Stock activity 920, and a Process Order activity 930. In the sample display 900, four instances are shown along a horizontal axis 940. These four instances, BP1, BP2, BP3, and BP4, are further displayed by their constituent activities of Check Credit, Check Stock, and Process Order by color, shading, or patterns. The display further indicates a duration for the activities along the vertical axis 950. The sample display 900 provides an at-a-glance indication that the Check Credit activity of the BP3 instance took longer than comparable Check Credit activities of other instances.

One embodiment of the present invention allows a business analyst to select which of the available parameters are monitored. In another embodiment, the available parameters are monitored and the business analyst selects which parameters to analyze. In yet another embodiment, parameters from other sources, including non-real time sources such as accounting applications, are collected and related to the activity or instance as applicable. Examples of parameters from monitored sources and external sources include time, revenues, profitability, customer return rates, whether a customer is a repeat customer, seasonal information, quantities, referral sources, ingredients, component part numbers, vendor sources, profits, costs, sales taxes, and the like.

Embodiments of the present invention can further include user interfaces, such as graphical representations, to facilitate statistical analysis of the parameters for the business analyst. Following the capture of multiple instances of a process, the statistical analysis assists the business analyst to correct deficiencies in processes, monitors the effect of changes to processes, sorts through data by ingredient or component used in a process, analyzes seasonal trends, and the like.

The parameters can be correlated with time metrics to identify parameters that have the most likely influence on process delays. In many cases, the statistical analysis of a business process focuses on minimizing the amount of time that the process takes to execute. In other situations, the statistical analysis can focus on other aspects of the process, such as maximizing a profit, minimizing a production cost, predicting a business trend, identifying of reasons for customer returns, and the like. For example, attributes related to source, quantity, customer type, and a time of the year can be correlated with output parameters such as time, profitability, return rates, and volume of sales.

For example, if a duration for the completion of a particular business process is correlated with the source of goods, ingredients, components, and the like, the business analyst can quickly determine which sources result in delays in the completion of the business process and can change the sources accordingly. The system can be configured to correlate multiple parameters. In another example, the system can correlate 3 parameters, such as correlation between shipping weight, season or weather conditions, and shipping time.

The monitored parameters can further be related to and correlated with data from non-real time external sources such as an accounting application that provides a per unit profit, which can be calculated quarterly.

In one embodiment, the statistical analysis includes a graphical tool to allow the business analyst to select a chart suitable for the presentation of the statistical analysis. Such charts include bar charts, pie charts, X-Y scatter charts, X-Y line charts, and the like. As described in connection with FIG. 9, an instance or an activity can be identified from another instance or activity on a chart by color, shading, or patterns.

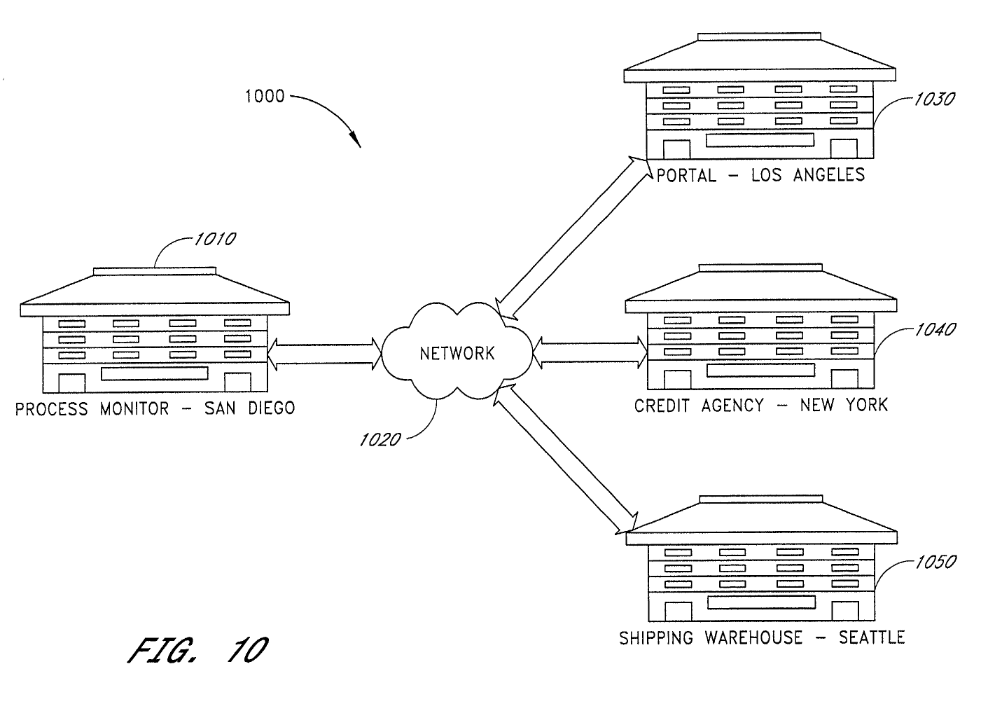

FIG. 10 illustrates a top-level view of the system in use in a business-to-business environment 1000. In FIG. 10, an exemplary business process executes at four remote locations. A Process Monitor system 1010 monitors and controls the business process in a San Diego office. The Process Monitor system 1010 communicates through a network 1020 to other business partners. The network 1020 can include the Internet as well as private networks and wireless communication. The business partners, as illustrated in FIG. 10, are a Portal 1030, a Credit Agency 1040, and a Shipping Warehouse 1050. As indicated by FIG. 10, the business partners are located in Los Angeles, New York, and Seattle, respectively.

An embodiment of the present invention can advantageously monitor the activities of a business process under one roof. In this case, the San Diego office 1010, can monitor the activities even though the process itself executes with the cooperation of a variety business partners running a variety of applications to execute the activities of the process.

A model of the business process is created and the model is executed by the Process Monitor system 1010. The activities at the Portal Agency 1030, the Credit Agency 1040, and the Shipping Warehouse 1050 are activated by, for example, placing tasks in a queue. Additional data conversion software or hardware allows the systems residing at the Portal Agency 1030, the Credit Agency 1040, and the Shipping Warehouse 1050 to access the queue through the network 1020. In one embodiment, the model is incorporated into the software and the system that controls the queue. In another embodiment, the model executes only within the Process Monitor system 1010, and passively observes interaction at the queue.

When an instance of the business process is executed, an instance of the model is correspondingly executed. The activities corresponding to the monitored business process are detected at the queue and monitored as the activities are reported over the network. The activities of many instances of the business process are monitored and tracked. An activity is further identified in a data store with the instance to which the activity belongs. Thus, the system can retain a history of the individual instances of the process.

Ready inspection of the individual instances and characteristics thereof allow a business analyst to determine, for example, if a problem with an instance of an activity is frequent and in need of correction or merely a random anomaly. Identification of problems is often not possible with summarized data. Without ready access to detail of individual instances of the process, the analyst may be left to examine summarized or averaged data, where important detail is lost. For example, averaged data, such as an average duration of time, can be quite misleading when the averaged data includes samples with no theoretical upper limit, such as samples of durations where some items were out of stock for long periods of time.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method of performing business process analysis, wherein systems that perform activities of a monitored business process and a control for the monitored business process communicate by storing and retrieving entries in a first data store, the method comprising:
maintaining a model of the business process, where elements of the model correspond to activities of the monitored business process;
storing parameters of activities of the monitored business process in a second data store and identifiably storing a relationship among the stored parameters of activities of individual instances of the monitored business process;
detecting an update to the first data store;
retrieving an updated content from the first data store;
determining whether the updated content corresponds with an activity belonging to the monitored business process; and
identifiably storing a parameter of the activity and storing a relationship of the activity to an instance to which the activity belongs when the activity corresponds to the monitored business process.

2. The method as defined in claim 1, further comprising allowing a user to select the parameter from the updated content that is stored in the second data store.

3. The method as defined in claim 1, further comprising detecting the update to the first data store by receiving an interrupt from the first data store.

4. The method as defined in claim 1, further comprising detecting the update to the first data store by polling the first data store.

5. The method as defined in claim 1, further comprising computing a parameter by measuring a time between activation of the activity and completion of the activity.

6. The method as defined in claim 1, wherein the first data store comprises:
a first queue that allows the control to store entries corresponding to activities to be performed by the systems; and
a second queue that allows the systems to store entries corresponding to status for the activities.

7. The method as defined in claim 1, further comprising controlling the business process with the model of the business process.

8. The method as defined in claim 1, further comprising:
monitoring a plurality of instances of the business process;
retrieving at least a portion of the plurality of instances; and
performing a statistical analysis on the at least portion of the plurality of monitored instances.

9. A method of performing business process analysis, wherein systems that perform activities of a monitored business process and a control for the monitored business process communicate over a network by storing and retrieving entries in a first data store, the method comprising:
maintaining a model of the business process, where elements of the model correspond to activities of the monitored business process;
storing parameters of activities of the monitored business process in a second data store and identifiably storing a relationship among the stored parameters of activities of individual instances of the monitored business process;
monitoring network traffic to and from the first data store;
identifying data in the network traffic that relates to the monitored business process and capturing the identified data; and
storing a parameter of the corresponding activity from the captured data and relating the parameter to an instance of the business process by storing a relationship of the activity to the instance to which the activity belongs.

10. The method as defined in claim 9, further comprising allowing a user to configure storage in the second data store of a selected parameter from a plurality of parameters in the captured data.

11. The method as defined in claim 9, further comprising controlling the business process with the model of the business process by enabling an element of the model to activate the element's corresponding activity.

12. A method of identifying bottlenecks of an automated business process for business process analysis by collecting detailed metrics and attributes of individual instances of the automated business process, the method comprising:
interconnecting multiple computer systems through a network, where the multiple computer systems perform states of the business process;
creating a model of the automated business process wherein elements of the model corresponds to states of the automated business process;
translating messages for at least one of the multiple computer systems such that a control system can communicate with the multiple computer systems to initiate states for the business process;
monitoring the translated messages on the network;
detecting a request related to initiation of an instance of the automated business process;
initiating an instance of the model for the business process;
identifiably maintaining elements in the model for the business process such that the elements corresponding to the instance of the business process are related;
detecting a start time for a state of the automated business process and storing the start time in the corresponding element of the instance of the model; and
detecting an end time for the state of the automated business process and storing the end time in the corresponding element of the modeled business process.

13. The method as defined in claim 12, further comprising:
allowing a user to select a business metric of a state to be monitored;
monitoring the business metric over the network;
identifiably storing the business metric such that the business metric can be identified with the state and the instance.

14. The method as defined in claim 13, wherein the business metric is an indication of whether an item ordered through an e-commerce implementation of the automated business process is in stock.

15. The method as defined in claim 12, further comprising detecting and storing a start and a stop time for all the states of the entire automated business process.

16. The method as defined in claim 12, wherein the states of the automated business process are modeled as elements of the modeled business process in a one-to-one relationship.

17. The method as defined in claim 12, wherein the model for the automated business process is incorporated into a control for the automated business process.

18. The method as defined in claim 12, further comprising computing a duration for the state by subtracting the start time from the end time.

19. The method as defined in claim 12, further comprising displaying a plurality of elements of the modeled business process and displaying an efficiency attribute related to the states corresponding to the elements.

20. The method as defined in claim 19, wherein the efficiency attribute is selected from a duration of the state, a success/failure indication for the state, and a cost associated with the state.

21. A method of monitoring an efficiency of a distributed process for business process analysis, the method comprising:
creating a model of at least a portion of a process flow, where the modeled process defines the process flow into activities;
communicating with a plurality of remote computer systems, where a remote computer system performs an activity of the distributed process;
initiating an instance of the process flow of the distributed process;
controlling the process flow by communicating with the remote computer systems to activate states of the modeled process flow;
tracking time metrics, wherein a time metric includes a duration of time from an initiation of an activity to a completion of the activity;
maintaining the time metrics in the data store;
collecting a process attribute associated with the instance; and
identifiably maintaining in the data store, the time metrics and the specified process attributes to the instance of the process flow.

22. The method as defined in claim 21, wherein a user can select a process attribute to collect from a plurality of available process attributes.

23. The method as defined in claim 21, wherein the efficiency monitored relates to monitoring a process bottleneck.

24. The method as defined in claim 21, wherein the efficiency monitored relates to monitoring an effect of a change in a business process.

25. The method as defined in claim 21, further comprising correlating the time metrics with the specified process attributes to provide an indication of a likely source of a bottleneck.

26. The method as defined in claim 21, further comprising correlating the time metrics with the changes to a process to provide an indication of a result of the changes to the process.

27. The method as defined in claim 21, further comprising:
monitoring a plurality of instances of the distributed process;
retrieving at least a portion of the plurality of monitored instances; and
performing a statistical analysis on the at least portion of the plurality of monitored instances.

28. The method as defined in claim 27, wherein the statistical analysis is used to display a bar chart, wherein different instances are arranged along an x-axis, and corresponding order quantities are arranged along a y-axis.

29. The method as defined in claim 27, wherein the statistical analysis is used to display an X-Y plot, wherein calendar days are arranged along an x-axis, and a customer return-rate is arranged along a y-axis.

30. The method as defined in claim 21, further comprising:
communicating with an external application that maintains an attribute related to at least one activity of the distributed process; and
receiving the attribute from the external application, and relating the attribute to the at least one activity.

31. The method as defined in claim 21, further comprising retrieving and displaying the stored time metrics from the data store.

32. The method as defined in claim 21, further comprising compensating for inactive periods in the calculation of the time metric.

33. The method as defined in claim 21, further comprising:
accumulating multiple time metrics corresponding to multiple instances of the process flow; and
displaying a set of time metrics corresponding to instances from the multiple instances of the process flow.

34. The method as defined in claim 21, further comprising:
accumulating multiple time metrics corresponding to multiple instances of the process flow;
selecting an activity of the process flow;
classifying instances of activities according to ranges of time, the ranges of time corresponding to the time metric; and
computing and displaying a histogram, where the histogram illustrates frequencies of classes of activities versus ranges of time.

35. The method as defined in claim 21, further comprising:
comparing in real time, a time variable with a time metric of an activity currently in progress; and
providing an alert when the time metric exceeds the time variable.

36. The method as defined in claim 35, further comprising enabling an inclusion of a remark upon occurrence of the alert, the remark identified as corresponding to the activity exceeding the time variable.

37. The method as defined in claim 21, further comprising:
accumulating multiple time metrics corresponding to multiple instances of the process flow;
maintaining a plurality of time variables, where a time variable is related to a duration of a monitored activity;
selecting a display instance from the multiple instances, where at least one activity of the display instance exceeded the corresponding time variable; and
displaying the modeled business process as a flowchart, where the flowchart represents activities of the modeled business process as objects, where an object includes a name of the corresponding activity and the time metrics corresponding to the selected display instance.

38. The method as defined in claim 37, wherein the corresponding time variable is the maximum expected duration for the corresponding activity.

39. The method as defined in claim 37, wherein the corresponding time variable is configurable by the user.

40. The method as defined in claim 37, wherein the corresponding time variable is within a range of 2 to 5 times an expected amount.

41. The method as defined in claim 21, further comprising:
accumulating multiple time metrics corresponding to multiple instances of the process flow;
displaying a list of at least a portion of the multiple instances of the process flow;
enabling a user to select an instance from the list; and
displaying a flowchart of the process flow, where the flowchart includes a duration for the activities of the instance.

42. The method as defined in claim 21, further comprising displaying the modeled business process as a flowchart, where the flowchart represents activities of the modeled business process as objects, where an object includes a name of the corresponding activity and the corresponding time metric for the activity.

43. The method as defined in claim 42, further comprising emphasizing an object in the flowchart that corresponds to an activity of the instance that took the longest time.

44. The method as defined in claim 42, further comprising emphasizing an object in the flowchart according to a state of the corresponding activity.

45. The method as defined in claim 44, wherein the state is selected from a waiting state, a running state, a done state, a failed state, a roll-back state, and an aborted state.

46. An analyzer for evaluating business processes, wherein systems that perform activities of a monitored business process and a control for the monitored business process communicate by storing and retrieving entries in a first data store, the analyzer comprising:
means for maintaining a model of the business process, where elements of the model correspond to activities of the monitored business process;
means for storing parameters of activities of the monitored business process in a second data store and identifiably storing a relationship among the stored parameters of activities of individual instances of the monitored business process;
means for detecting an update to the first data store;
means for retrieving an updated content from the first data store;
means for determining whether the updated content corresponds with an activity belonging to the monitored business process; and
means for identifiably storing a parameter of the activity and storing a relationship of the activity to an instance to which the activity belongs when the activity corresponds to the monitored business process.

47. An analyzer for performing analysis of distributed business processes, the analyzer comprising:
a network device adapted to communicate with external systems, where an external system performs an activity of the business process;
a translating module adapted to translate a message to and from a first format to a second format, where the first format corresponds to a message format of the analyzer and the second format corresponds to a message format of the external system;
a queuing module adapted to initiate activities of the distributed business process;
a memory device adapted to store data, where the data stored includes a model for the business process, where the model includes stages that correspond to activities of the business process, and where the memory device is further adapted to store parameters of an instance of the business process such that the stored parameters for the instance are identifiably maintained from stored parameters for other instances;
a data retrieve module adapted to retrieve data from the memory device, where the data retrieve module relates a stage from the model of the business process to the activity such that the first system identifies the second system from the other systems; and
a data store module adapted to use the network device to communicate with the second system to monitor the activity and to store the performance related parameter in the data device and is further adapted to relate the parameter to the instance to which it applies.

48. The system as defined in claim 47, further comprising a display device adapted to present a compilation of a plurality of collected parameters of instances of the business process.

49. A tracking system that tracks and analyzes business metrics for analyzing a business process wherein the business process includes a first activity and a second activity, where the first activity is performed by a first activity system with a first translating module and the second activity is performed by a second activity system with a second translating module, the tracking system comprising:
a controlling system adapted to communicate with the first and the second activity systems to activate the first and the second activities;
a translating system adapted to reformat data such that the controlling system can communicate with the first and the second activity systems;
a monitoring system adapted to track the business process with a model of the business process, the monitoring system further adapted to detect a communication that corresponds with an activity of the business process, to capture a metric of the activity and identifiably relate a plurality of metrics of activities corresponding to an instance of the business process; and
an analysis system adapted to retrieve the captured metrics and to retrieve the related plurality of metrics such that a business analyst can analyze the business process.

50. The tracking system as defined in claim 49, wherein the translating system further comprises:
an input queue adapted to store messages from the controlling system to the first and the second activity systems;
an output queue adapted to store messages from the first and the second activity systems to the controlling system;
a first application interface adapted to convert messages from a first format corresponding to the first activity system to a controlling system format, the first application interface further adapted to convert messages from the controlling system to the first format; and
a second application interface adapted to convert messages from a second format corresponding to the second activity system to the controlling system format, the second application interface further adapted to convert messages from the controlling system to the second format.

51. The tracking system as defined in claim 49, wherein the monitoring system is further adapted to permit a user to configure the monitoring system such that the monitoring system selectively collects metrics specified by the user.
